(19) United States
(12) Patent Application Publication
(10) Pub. No.: US 2006/0127616 A1
(43) Pub. Date: Jun. 15, 2006

(54) Controlled infrared/fluid coating cure process

(75) Inventor: Edwin Beck, York, PA (US)

Correspondence Address: VENABLE LLP, P.O. BOX 34385, WASHINGTON, DC, 20045-9998, US

(73) Assignee: GRAHAM PACKAGING COMPANY, L.P., York, PA (US)

(21) Appl. No.: 11/008,736

(22) Filed: Dec. 10, 2004

(51) Int. Cl. B32B 27/08

(52) U.S. Cl. 428/35.7; 427/487; 427/162; 427/160; 427/372.2

(57) ABSTRACT

A method of curing a heat curable coating on a heat sensitive substrate includes initially heating the coated substrate by exposure to infrared radiation in order to increase the temperature at a point near to the coating with time, and subsequently heating the coated substrate by contact with a warm fluid in order to increase the temperature at a point near to the coating with time. After subsequently heating the coated substrate, the coating can be substantially cured, the coating can have good optical quality, and the heat sensitive substrate can be not substantially deformed.

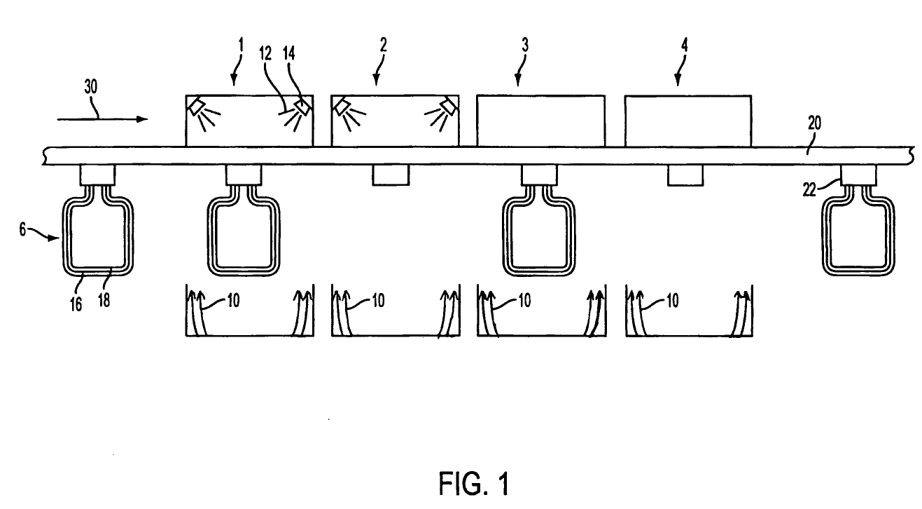

### BACKGROUND OF THE INVENTION

1. Field of the Invention

This invention relates to a method of curing a heat curable coating on a heat sensitive substrate. Specifically, the invention also relates to a curing process wherein heat can be applied through infrared radiation and contact with a fluid in a first heat curing stage and can be applied through contact with a fluid in a second heat curing stage. A method for optimizing parameters of the curing process is encompassed by the invention.

2. Description of the Related Art

The coating of polymeric substrates plays a crucial role in manufacturing products with required properties for a range of industries. The fact that a composite product is formed from a coating having a first set of properties and from a substrate having a second set of properties enables manufacturers to tailor products for specific applications, optimize the multiple characteristics of a product to a degree not possible with a unitary material, and lower costs.

For example, coatings may be used to impart gas barrier or semipermeable gas properties to packaging materials which are, by themselves, gas permeable. Such gas barrier properties can result in longer shelf life of food products. For example, many foods have longer shelf life when oxygen from the environment is excluded; carbonated beverages have longer shelf life before “going flat” when carbon dioxide is retained within the package.

A synthetic polymer is a common substrate for packaging materials. Polymer materials are advantageous packaging materials because they are low in cost, shatter resistant, highly recyclable, and light weight. However, many polymers, including, for example, polyethylene terephthalate (PET) and polyethylene are permeable to gases such as oxygen and carbon dioxide. Gas permeability can be undesirable and detrimental for some uses. Polymers which have low gas permeability can be too expensive to use as the only component of a food packaging material.

Coating a material that uses a low cost polymer as the structural material with a coating material having good gas barrier properties offers an economically feasible food packaging material with favorable properties. Epoxy based coatings are an example of coatings which can impart a gas barrier property to packages. Epoxy based coatings are applied to a substrate and then cured, i.e., crosslinked, in order to adhere to the substrate, provide mechanical stability, and provide an attractive glossy optical appearance. The curing process is typically accelerated in a heat cure process: the coated substrate is exposed to an elevated temperature for a period of time. Coatings of which cure can be accelerated by exposure to elevated temperature are termed heat curable coatings. Examples of heat curable, epoxy based coatings useful in gas barrier applications are found in U.S. Pat. Nos. 6,309,757 and 5,902,643 to Carlblom et al. and U.S. Pat. No. 5,438,109 to Nugent et al., each of which is incorporated herein by reference in its entirety.

However, current problems in the art preclude more extensive application of the heat cured epoxy coating approach with polymer substrates. For example, when heat is applied in order to cure a coating on a heat sensitive substrate, mechanical deformation of the substrate can result. Many low cost polymers used in packaging applications, e.g., PET and polyolefins such as polyethylene and polypropylene, exhibit such heat sensitivity. Deformation of the substrate is understood to depend on the temperature to which the substrate is exposed, the time for which the substrate is exposed to the temperature, and the load imposed on the substrate. Unlike a melting transition, softening of the substrate takes place over a range of temperatures. Nevertheless, it is convenient to define a softening temperature, below which distortion of the substrate will generally not be a problem, and above which distortion of the substrate will be a problem. An example of a softening temperature which can serve as a measure is the heat distortion temperature defined by the ISO 75 HDT/B test. For example, under the ISO 75 HDT/B test, PET has a heat distortion temperature of 115° C., high density polyethylene has a heat distortion temperature of 86° C., and polypropylene has a heat distortion temperature of 85° C. Many other polyesters, polyolefins and polyolefin copolymers, as well as some polyamides, have similarly low heat distortion temperatures. When polymers used for packaging are referred to in this text, polymers which may exhibit heat sensitivity are implied. The heat curing process is thus limited by the softening temperature of the substrate; i.e., the heat applied must remain below the softening temperature, or the time of exposure to elevated temperature must be minimized. As a result of these limitations, several problems occur. For example, curing of the coating may be incomplete or the process may be too time consuming to be commercially feasible.

Rapid curing is another approach to effecting a complete cure without damaging the underlying substrate by minimizing the duration of exposure to high temperatures. However, rapid curing or drying of a coating can result in the formation of blisters and internal bubbles in the coating caused by gas evolved during the curing or drying process. These defects are thought to be caused by differential curing rates of the coating near the air-coating interface vis-a-vis the coating-substrate interface. The substrate restrains the evolved gas from escaping on the substrate side of the coating. If the coating material close to the air-coating interface cures or dries too rapidly, a “skin” will be formed at this interface. This skin can trap gas evolved from the drying or curing of deeper layers of the coating, e.g., near the coating-substrate interface. This can result in the formation of blisters, i.e., raised bumps on the surface of the coating, pockmarks, i.e., ruptured blisters, or trapped bubbles which can compromise the integrity of the coating and result in an unacceptable appearance, i.e., poor optical quality.

U.S. Pat. No. 4,771,728, to Bergman, and U.S. Pat. Nos. 4,907,533, 4,908,231, and 4,943,447 to Nelson et al., each of which is incorporated herein by reference in its entirety, disclose methods and apparatus for drying and curing a coating applied to an automobile body in which the coating is first “set” by applying infrared radiation and the curing or drying is then subsequently completed by passing flowing warm air over the coated surfaces. However, these patents do not mention the drying or curing of coatings on polymeric substrates and do not address the control of the temperature of the substrate during treatment so as not to damage a polymeric substrate.

In U.S. Pat. No. 6,231,932 B1, which is incorporated herein by reference in its entirety, Emch discloses a method for curing a coating on automotive parts. The curing of coatings on polymeric substrates and the need to remain below a heat distortion temperature, is discussed. However, the method presented in U.S. Pat. No. 6,231,932 B1 discloses temperature ranges for drying of a coating of 130-150° C. on a polymeric substrate, considerably higher than, for example, the ISO 75 HDT/B temperatures of a number of polymers used in packaging applications. U.S. Pat. No. 6,231,932 B1 mentions the curing of a coating “by holding the peak metal temperature at a target of about 130° C. to about 150° C. for about 10 to about 20 minutes”, i.e., inducing curing by holding a metal substrate at a high temperature for a long period of time.

In U.S. Pat. No. 6,200,650 B1 to Emch, which is incorporated herein by reference in its entirety, an example of drying a primer coating on a polyphenylene oxide/nylon automobile part is disclosed. In the example presented in the patent, the part was heated to a peak temperature of 156° C. to dry the primer coating. Such a temperature would rapidly deform low cost polymers used in packaging.

U.S. Pat. No. 6,291,027 to Emch, which is incorporated herein by reference in its entirety, discloses a method of drying a coating on a polymer substrate. No specific information regarding operating parameters for curing a coating within a commercially realistic time without distorting a polymeric substrate with a low heat distortion temperature, i.e., a low softening temperature, is provided.

In short, the prior art does not present a method for simultaneously achieving the goals of rapid cure, full cure, and good optical quality of a coating without deformation of a polymer substrate suitable for packaging applications in general and for low weight containers in particular. There is a need for a process that can achieve a high fraction of cure of heat curable coatings without deformation of the substrate or the formation of blisters or internal bubbles on or in the coating.

### SUMMARY OF THE INVENTION

It is therefore an object of the present invention to provide novel methods for achieving a high fraction of cure of a heat curable coating without the formation of blisters, pockmarks or internal bubbles on or in the coating and without substantial deformation of a heat sensitive substrate. A claimed method uses heating by infrared radiation and by a warm fluid to increase the temperature of a point near to the coating with time and to cure the coating. Rapid and full cure of the coating can be achieved with the coating having good optical quality and the substrate not being deformed.

A method of curing a heat curable coating on a heat sensitive substrate according to the present invention includes providing a heat sensitive substrate coated with an uncured heat curable coating, initially heating the coated substrate by exposure to infrared radiation in order to increase the temperature at a point near to the coating with time, and subsequently heating the coated substrate by contact with a warm fluid in order to increase the temperature at a point near to the coating with time. After subsequently heating the coated substrate, the coating can be substantially cured, the coating can have good optical quality, and the heat sensitive substrate can be not substantially deformed. Initially heating can include heating in a controlled manner and subsequently heating can include heating in a controlled manner. The heat sensitive substrate can comprise a food packaging container.

In a method according to the present invention, the temperature of the heat sensitive substrate does not exceed about 125° C. The heat sensitive substrate can include a polymer having a softening temperature of less than about 100° C. The heat sensitive substrate can include, for example, a polymer such as a polyester, polyethylene terephthalate, a polyolefin, polyethylene, high density polyethylene, polypropylene, a polyamide, nylon 6, nylon 12, or nylon 66. The uncured heat curable coating can include an epoxy formulation; for example, the uncured heat curable coating can include an amine and an epoxide.

In a method according to the present invention, the temperature of the heat sensitive substrate does not exceed about 105° C. The heat sensitive substrate can be a polymer substrate. The total duration of the initial heating and the subsequent heating can be from about 300 to about 350 seconds.

In a method according to the present invention, the temperature of the heat sensitive substrate does not exceed about 88° C. A source of the infrared radiation can be selected to have a spectrum wherein more infrared radiation per a unit substrate mass is absorbed by the substrate than infrared radiation per a unit coating mass is absorbed by the coating. The infrared radiation can be produced by heating a radiator to a selected radiator temperature and/or by ohmic heating of a pre-selected filament. The infrared radiation can be produced from a reflector of a pre-selected material.

The temperature of the heat sensitive substrate during the initial heating can be less than the softening temperature of the heat sensitive substrate. The temperature of a point near to the coating can be greater than the glass transition temperature of the coating substantially throughout the initial heating and substantially throughout the subsequent heating. The difference between the temperature of a point near to the coating and the glass transition temperature of the coating can be greater at a beginning of the initial heating than at an end of the subsequent heating.

In a method according to the present invention, the difference between the temperature of a point near to the coating and the glass transition temperature of the coating is in the range of from about 5° C. to about 50° C. substantially throughout the initial heating and substantially throughout the subsequent heating. Not substantially deformed can mean the longest perimeter around a container comprising the heat sensitive substrate decreasing between the start of initial heating and the end of subsequent heating by less than or equal to about 2%, by even less than or equal to about 1%, or by even less than or equal to about 0.5% between the start of initial heating and the completion of subsequent heating. The warm fluid can include warm air. The temperature of a temperature probe in the vicinity of the heat sensitive substrate can increase in a stepwise manner during the initial heating and during the subsequent heating. The irradiance of the coating by infrared radiation can be varied during exposure of the coated substrate to the infrared radiation. The temperature of the warm fluid and/or the flow rate of the warm fluid can be varied during contact of the coated substrate with the warm fluid. The initial heating and the subsequent heating can be conducted in an oven.

A method of curing a heat curable coating on a heat sensitive substrate according to the present invention includes providing a heat sensitive substrate coated with an uncured heat curable coating, initially heating the coated substrate by exposure to infrared radiation and by contact with a warm fluid, and subsequently heating the coated substrate by contact with a warm fluid and not by exposure to infrared radiation. After subsequently heating the coated substrate, the coating can be substantially cured, the coating can have good optical quality, and the heat sensitive substrate can be not substantially deformed. An oven can be provided for supplying the infrared radiation and the warm fluid for the initial heating, and a different oven can be provided for supplying the warm fluid for the subsequent heating. The initial heating can include exposing the coated substrate to conditions in a first oven for from about 10% to about 15% of a total heat curing time, and the first oven can maintain an air temperature of from about 80° C. to about 85° C. The initial heating can include exposing the coated substrate to conditions in a second oven for from about 10% to about 30% of a total heat curing time, and the second oven can maintain an air temperature of from about 77° C. to about 82° C. The subsequent heating can include exposing the coated substrate to conditions in a third oven for from about 25% to about 40% of a total heat curing time, and the third oven can maintain an air temperature of from about 83° C. to about 87° C. The subsequent heating can include exposing the coated substrate to conditions in a fourth oven for from about 25% to about 40% of a total heat curing time, and the fourth oven can maintain an air temperature of from about 86° C. to about 90° C. The total heat curing time can be from about 300 to about 550 seconds; the total heat curing time can be about 320 seconds.

A method according to the present invention includes conveying the coated substrate through a first oven, exposing the coated substrate to conditions in the first oven for from about 10% to about 15% of a total heat curing time, and maintaining an air temperature in the first oven of from about 80° C. to about 85° C. The method can include conveying the coated substrate through a second oven after having conveyed the coated substrate through the first oven, exposing the coated substrate to conditions in the second oven for from about 10% to about 30% of the total heat curing time, and maintaining an air temperature in the second oven of from about 77° C. to about 82° C. The method can include conveying the coated substrate through a third oven after having conveyed the coated substrate through the second oven, exposing the coated substrate to conditions in the third oven for from about 25% to about 40% of the total heat curing time, and maintaining an air temperature in the third oven of from about 83° C. to about 87° C. The method can include conveying the coated substrate through a fourth oven after having conveyed the coated substrate through the third oven, exposing the coated substrate to conditions in the fourth oven for from about 25% to about 40% of the total heat curing time, and maintaining an air temperature in the fourth oven of from about 86° C. to about 90° C. The total heat curing time can be from about 300 seconds to about 350 seconds.

A method of optimizing curing of a heat curable coating on a heat sensitive substrate according to the present invention includes setting oven controls to an initial set of parameters for an oven, exposing a heat sensitive substrate coated with an uncured heat curable coating to conditions in the oven, measuring at least one physical-chemical property of the coated substrate, and adjusting the oven controls for the oven. The at least one physical-chemical property can include substrate deformation, coating surface optical quality, glass transition temperature of the coating, coating cure fraction, coating cure uniformity, and coating temperature; the at least one physical-chemical property can be measured while the coated substrate is in the oven or after the coated substrate is removed from the oven. The steps of exposing the coated substrate to conditions in the oven, measuring at least one physical-chemical property of the coated substrate, and adjusting the oven controls for the oven can be repeated until at least one physical-chemical property of the coated substrate meets a predetermined specification. The method can further include initially setting oven controls for at least one additional oven, exposing the heat sensitive substrate coated with the uncured heat curable coating to conditions in the at least one additional oven, measuring at least one physical-chemical property of the coated substrate, and adjusting the oven controls for the at least one additional oven. The at least one physical chemical property can be measured while the coated substrate is in the at least one additional oven or after the coated substrate has been removed from the at least one additional oven. The steps of exposing the coated substrate to conditions in the at least one additional oven, measuring at least one physical-chemical property of the coated substrate, and adjusting the oven controls for the at least one additional oven can be repeated until at least one physical-chemical property of the coated substrate meets a predetermined specification.

In an embodiment of the present invention, a container includes a thermoplastic substrate and a crosslinked epoxy coating on the thermoplastic substrate. The crosslinked epoxy coating can be substantially smooth and uniform. The glass transition temperature of a coating, e.g. a crosslinked epoxy coating, can be greater than the glass transition temperature of a heat sensitive substrate, e.g. a thermoplastic substrate. When a container is heated above the glass transition temperature of a heat sensitive substrate, e.g., a thermoplastic substrate, for a time period sufficient for residual stresses in the substrate to relax, the longest perimeter around the container can decrease by at least about 0.3%, or can even decrease by at least about 0.5%. A thermoplastic included in the substrate can be chosen from a polyester, polyethylene terephthalate, a polyolefin, polyethylene, high density polyethylene, polypropylene, a polyamide, nylon 6, nylon 12, and nylon 66, or any combination of these. The crosslinked epoxy coating of the container can have good optical quality and can be optically clear. The coating can include an amine and an epoxide.

In an embodiment of the present invention, a container has a coating cured by a method including initially heating an uncured heat curable coating coated onto a heat sensitive substrate by exposure to infrared radiation in order to increase the temperature at a point near to the coating with time, and subsequently heating the coated substrate by contact with a warm fluid in order to increase the temperature at a point near to the coating with time. After subsequently heating the coated substrate, the coating can be substantially cured, the coating can have good optical quality, and the heat sensitive substrate can be not substantially deformed. The heat sensitive substrate of the container can include a thermoplastic and the coating can include a crosslinked polymer, such as a crosslinked epoxy.

### BRIEF DESCRIPTION OF THE DRAWING

The FIGURE is a schematic view of an embodiment of the invention wherein the coated substrate passes through a series of ovens in order to effect curing.

### DETAILED DESCRIPTION OF THE INVENTION

In describing preferred embodiments of the present invention, specific terminology is employed for the sake of clarity. However, the invention is not intended to be limited to the specific terminology so selected. All references cited herein are incorporated by reference as if each had been individually incorporated.

Curing an appropriate curable coating on the surface of a substrate comprised of a low cost polymer used for packaging can be used to produce a food packaging material with good gas barrier properties, for example, a food packaging material with low permeability to oxygen and carbon dioxide. The curable coating can cure to form a crosslinked polymer. For example, the curable coating can be an epoxy formulation. A high fraction of cure is desirable and often necessary. If the coating is not fully cured, the coating can wear away, become marked, impart an undesirable optical appearance, be tacky, have an odor, or be at least somewhat gas permeable.

It is believed that during the curing process, corresponding reactive groups on the uncured components of a coating can react to form a polymeric structure. When these groups react, a covalent bond is formed between a first molecule and a second molecule. For example, in the case of an epoxy coating, corresponding reactive groups are a hydroxy or amine group on a first molecule and an oxirane group on a second molecule. Of course, not all reactive groups form bonds simultaneously. The number of reactive groups which have reacted divided by the total number of reactive groups present in the uncured components of a coating is the fraction of cure of a coating. At a high fraction of cure, almost all of the initial molecules are covalently bonded to another molecule to form a continuous network. When nearly all of the reactive groups have reacted, the coating is deemed fully cured.

Several challenges must be met in a curing process. These include 1) achieving a high fraction of cure of the coating within a short time, 2) avoiding blisters and other coating defects, and 3) avoiding damage to or deformation of the underlying substrate.

Achievement of a required high fraction of cure within a short time, that is, a high cure rate, is desirable to maximize the throughput rate of product through equipment in an industrial process. The cure rate is believed to increase as the temperature increases for several reasons. For example, the increase in kinetic energy of molecules associated with a temperature increase can increase the intermolecular collision rate and increase the number of functional groups which have sufficient energy to overcome reaction activation energies.

The fraction to which the coating is already cured can affect the rate of cure. It is understood that when the fraction of cure is low, the motion of reactive groups is only constrained by the viscosity of the surrounding medium. However, when the fraction of cure is high, many reactive groups are bound to the polymer network and the motion of these reactive groups is constrained. As a result, the number of contacts of corresponding reactive groups per unit time decreases and the rate of cure at a given temperature decreases.

Moreover, at temperatures above the glass transition temperature of a polymer coating, polymer chains and large chain segments are believed to move more freely than at lower temperatures. As a result, the curing process proceeds more rapidly above the glass transition temperature; that is, reactive groups on free molecules and on bound molecules can come into contact and react. Below the glass transition temperature, polymer chains and large chain segments move very slowly. When the temperature falls below the glass transition temperature, the rate of cure decreases dramatically. As the fraction of cure increases, molecules and chain segments become more constrained, so that the glass transition temperature of a coating increases with the fraction of cure. As an example, a process can be considered in which a cure oven temperature is held constant at the glass transition temperature corresponding to a coating with 70% cure. In this system, when the coating is completely uncured, the components of the coating can react and the rate of cure is high. As the fraction of cure increases, the glass transition temperature of the coating increases. Once the glass transition temperature of the coating reaches the temperature of the cure oven, that is, when the coating is 70% cured, the rate of cure slows dramatically. Thus, in this example, the fraction of cure is essentially limited to 70% by the temperature of the oven.

However, the maximum temperature at which a curing system can operate can be bounded; for example, the maximum operating temperature can often be bounded when the substrate to which the coating is applied is a low cost thermoplastic polymer. If the temperature in such a system exceeds a softening temperature of the thermoplastic polymer, the substrate will deform over time. Deformation associated with softening results in an undesirable appearance of a package and can compromise the integrity of the gas barrier and the mechanical strength of the package. Thermoplastic polymers that are not crosslinked, e.g., polyethylene terephthalate (PET) and polyethylene, are commonly used in food packaging materials. In a thermoplastic polymeric material, there is generally not a single, well defined melting temperature; rather, the material starts to soften at a given temperature and become ever softer as the temperature is increased. The extent of deformation of a thermoplastic polymer material is a function of the temperature, the duration of exposure to the temperature, and the load imposed on the material. Nevertheless, it is useful to define a softening temperature: below the softening temperature deformation of the material generally does not pose a problem and above the softening temperature deformation of the material can pose a problem. As used herein, the softening temperature is the temperature where deformation becomes problematic, i.e., the heat distortion temperature. Heat distortion temperatures are defined by standard tests, for example, the ISO 75 HDT/B test. The glass transition temperature of the coating represents the temperature which must be exceeded for cure to occur at a reasonable rate. If the oven temperature is set at a constant value above the softening temperature of the substrate, for example, because the glass transition temperature of the coating will exceed the softening temperature of the substrate during the curing process, the substrate will be prone to deform during the process, which can result in a product of little or no value.

Another concern in curing a coating on a polymeric substrate can be the formation of a problematic skin layer, especially in a rapid heat curing process. Rapid curing in an oven may cause the temperature of the coating material close to the air-coating interface to increase faster than the temperature of the coating closer to the substrate. Without being bound by theory, it is believed that a temperature gradient can develop during a rapid cure process wherein the temperature is highest at the air-coating interface and lowest at the coating-substrate interface. This temperature gradient can cause the coating material closer to the air-coating interface to cure more rapidly than the coating material closer to the coating-substrate interface. The more cured material close to the air-coating interface can thus become crosslinked early in the process to form a skin. Gas formed as a byproduct of the curing reaction of the coating material closer to the substrate diffuses or transports through the uncured coating material. However, gas can only diffuse slowly through the skin. Consequently, gas within the coating can become trapped beneath the skin and the trapped gas can accumulate into bubbles. Trapped bubbles can form blisters or, if the gas in the bubbles escapes by rupturing the viscous skin, can form defects such as pockmarks in the surface of the coating adjacent to the air. Defects such as blisters and pockmarks on a coating as well as bubbles trapped at intermediate coating depths can result in an undesirable appearance of a coated package and can compromise the integrity of the gas barrier by reducing the coating thickness in certain regions.

The methods according to the invention offer solutions to the challenges posed by the cure of coatings on polymeric substrates. The methods according to the invention include increasing the temperature, for example, the temperature of a point near to a coating, the temperature of the coating, or the temperature of a heat sensitive substrate, with time, and/or controlling the profile of temperature variation with the depth of the coating. Heating in a controlled manner can include increasing the temperature of a point near to the coating, the coating, or the heat sensitive substrate to achieve or approximate a predetermined temperature-time profile. Heating in a controlled manner can include heating to achieve a predetermined temperature-coating depth profile.

Methods according to the invention for optimizing oven control parameters are presented. According to the invention, increasing the temperature to which a heat sensitive substrate coated with an uncured heat curable coating is exposed during a curing process can be used to better obtain an essentially full cure of the coating without substantial deformation of the substrate.

In an embodiment, curing is induced by at first applying heat to an uncured heat curable coating on a substrate, for example, a heat sensitive substrate, so that the temperature of the coating is sufficiently high for the curing reaction to proceed, but the temperature of the coating, at least at first, is less than the softening temperature of the substrate. The heat sensitive substrate can be, for example, a thermoplastic. The temperature at a point near to the coating can be a close approximation of the temperature of the coating. A point near to the coating can be a point in the coating or touching the coating, or can be a point close to the coating, closer to the coating than to the substrate and not touching the substrate. For example, the temperature can be measured by a thermocouple, resistance temperature detector or thermistor 100 mm, 10 mm or 1 mm away from the surface of the coating or by a thermocouple, resistance temperature detector or thermistor touching the coating but not substantially touching the substrate. For example, when a volume in an oven including a given point and including the surface of the coating has an even temperature distribution of a fluid, such as air, and/or a constant irradiance of infrared radiation in the volume, the given point can be taken as a point near to the coating. For example, in a large oven, with an even temperature distribution of a fluid and/or a constant irradiance of infrared radiation over a large volume, a point near to the coating can be touching the surface of the coating or can be 1 mm, 10 mm, 100 mm, or farther from the surface of the coating. For example, in a small oven, a point near to the coating can be less than 1 mm from or touching the surface of the coating. The temperature near to the coating can be measured by a temperature probe. As curing of the coating proceeds, and the glass transition temperature of the coating increases, the temperature of the coating can be increased so that the temperature of the coating or the temperature at a point near to the coating remains above the glass transition temperature of the coating as the glass transition temperature increases to ensure continuing progression of cure of the coating to a greater fraction of cure.

The temperature of the coating can be increased by ramping heating parameters to greater values. For example, the temperature of a warm fluid, such as air, surrounding the coating and/or the substrate can be increased. The warm fluid can be circulated over the coating and/or the substrate and the velocity of the warm fluid can be increased to reduce the thickness of a thermal boundary layer over the coating. The intensity of infrared lamps, heaters or radiators directing infrared radiation onto the coating can be increased. The heating parameters can be increased in a controlled manner, so that the temperature of the coating increases at a predetermined rate.

Towards the end of the process, the glass transition temperature of the coating may exceed the softening temperature of the substrate. The ramping of temperature of the coating is believed to effect a substantially full cure within a short time without damaging the substrate because of the following. Because a large fraction of the cure was completed at earlier times during the curing process, with coating temperatures less than the softening temperature of the substrate, the time for which the coating temperature must exceed the softening temperature of the substrate in order to effect full cure is minimized. Although the coating is substantially cured, because the substrate is only exposed to a temperature greater than the softening temperature for a short period of time, the substrate is not substantially deformed.

This ramping approach is preferable to prior art approaches in which heat is applied to rapidly bring the coating to a high temperature and the high temperature is maintained throughout the cure process. In such prior art processes, the temperature of the coating can be much greater than that required for the cure reaction to proceed for most times in the process. If the temperature of the coating and of the substrate is greater than the softening temperature of the substrate throughout the time during which heat is applied, the substrate can substantially deform during the curing process.

Embodiments of the invention effect full cure without damaging the substrate through, for example, stepwise or continuous control of heating parameters. In an embodiment of a continuous control process, the parameters of the heat inducing device are continuously adjusted with the goal of achieving a suitable temperature-time curve for the coating. As mentioned above, a temperature-time curve is believed to be suitable when the temperature of the coating exceeds the glass transition temperature of the coating for all times spanned by the curve. In an embodiment, heating parameters such as the temperature or velocity of a warm fluid or the intensity of infrared lamps, heaters or radiators can be continuously varied, for example, continuously increased, in order to effect a suitable, for example, increasing, temperature-time curve for the coating.

In an embodiment of a stepwise control process, the parameters of the heat inducing device or devices remain set at substantially constant values when the heat inducing device or devices are on, but heat is only applied for limited durations. Heat may be applied for a first duration, after which no heat is applied for a second duration, after which heat is again applied for a third duration, and so forth. Such intermittent heating can be effected by, for example, allowing the coated substrate to remain in an oven for an extended duration and turning the heat inducing device on and off for specific durations, e.g., by turning the circulation of warm air on and off. Such an intermittent heating process can effect an increase in the temperature of the coating in a stepwise manner as follows. Heat, whether transferred to the coating by warm fluid or by infrared radiation directed onto the coating, takes a certain period of time to increase the temperature of the coating. At first, a low or moderate coating temperature, averaged over time, can be maintained by having a heat inducing device, e.g., a warm air circulator or an infrared lamp, on for only short durations and then off for longer durations. Later, a high coating temperature, averaged over time, can be maintained by having a heat inducing device on for long durations and off for only short durations, or on continuously.

In another embodiment of a curing process, the coated substrate is moved through a series of different ovens. The parameters of the heat inducing device or devices in a given oven remain set at substantially constant values, but the parameters for a given oven may be different from those of another oven. For example, an oven can have flowing warm air at a given temperature and/or an infrared lamp generating infrared radiation of a given intensity; the coated substrate may reside in the oven for a limited duration. The coated substrate can then be placed into another oven having flowing warm air at a greater temperature than the oven and/or having an infrared lamp generating infrared radiation which provides a greater irradiance of the coated substrate by infrared radiation than an infrared lamp in the oven. The coated substrate can temporarily reside in a space in which no heat is applied between the oven and the other oven. In such a process, the temperature of the coating can increase over time, but rather than increasing at a constant rate, the temperature of the coating can increase in a stepwise manner. For example, the temperature of the coating, or the temperature at a location near to the coating, can increase at a high rate when in the oven. Then, when the coated substrate resides temporarily in a space in which no heat is applied, such as between ovens, the temperature of the coating can remain constant or even decrease somewhat, although the coating can continue to cure. Once the coated substrate enters the other oven, the temperature of the coated substrate can again increase at a high rate. Although the temperature of the coating may stay constant or even decrease somewhat in the space between the ovens, the temperature of the coating is still considered to increase with time.

In addition to achieving rapid cure of a coating without deforming the underlying polymeric substrate, the ramping approach, applied to effect either a continuous or a stepwise increase in coating temperature, can preclude the formation of a coating skin and, therefore, preclude the formation of pockmarks, blisters, or trapped bubbles, and form a cured coating having good optical quality on a substrate. For example, a cured coating which is optically clear, i.e., which is transparent, can be formed on the substrate. Following the reasoning presented above, it is thought that the formation of a skin can be avoided if the cure reaction near the coating-substrate interface proceeds nearly as rapidly as the rate of reaction near the air-coating interface. The coating then has a similar viscosity throughout its thickness. Gas evolved near to the coating-substrate interface can travel through the coating to the air-coating interface and escape to the environment without being trapped by a skin. The temperature at all depths of the coating can be similar, so that the reaction near to the coating-substrate interface proceeds about as rapidly as the reaction near to the coating-air interface.

If the coating and substrate are rapidly heated by flowing air, a highly nonhomogeneous temperature versus coating depth profile can be established such that a skin of coating material with a high fraction of cure is rapidly formed at the air-coating interface. Gas evolved by or with less rapidly curing coating material at greater depths of the coating can then be trapped beneath this skin forming blisters, or if the blisters rupture, pockmarks. By contrast, when the temperature of the coating gradually increases with time, there is time for heat to transfer from the air-coating interface throughout all depths of the coating such that a more homogeneous temperature versus coating depth profile is maintained throughout the cure process. Such a gradual increase of coating temperature could be effected by the ramping approach, implemented to effect an increase in the coating temperature in a continuous or in a stepwise manner. In short, the ramping approach enables a high fraction of cure of the coating to be achieved within a short period of time without deforming the polymeric substrate and without resulting in defects, such as blisters, pockmarks or trapped bubbles, of the coating.

In an embodiment, the coating is heated by infrared radiation. The temperature-time curve at a given depth in the coating or in the substrate can be varied in a continuous manner. For continuous variation, the flux of the infrared radiation can be adjusted by varying the power supplied to the infrared emitters, e.g., infrared lamps, with time. In another version of the embodiment, the flux of the radiation is varied in a stepwise manner. For example, the coated substrate can be exposed to infrared radiation for a certain duration, after which no infrared radiation is applied for a certain duration, after which infrared radiation may again be applied for a certain duration, and so forth. The stepwise process can be carried out by, for example, switching infrared emitters on and off within an oven, or by, for example, passing the coated substrate through an oven with infrared heating followed by exposure to the room environment before the coated substrate enters a next oven.

When the substrate absorbs infrared radiation more strongly than the coating, the temperature of the coating at greater depths can be higher than the temperature of the coating at shallower depths; such a temperature profile can help to avoid the formation of blisters, pockmarks, or trapped bubbles of the coating. It is understood that the temperature-time curve at a given depth in the coating or in the substrate can be controlled by using infrared heating. Thus, infrared heating can be used to help avoid the formation of a skin on the coating by controlling the rate of deposition of thermal energy at various depths of the coating and the substrate during the heating process. It is believed that a portion of the infrared flux is absorbed by each depth within the coating and the substrate, so that heat is directly deposited through radiation at lower depths of the coating or substrate. As a result, by heating with infrared radiation, the temperature-depth profile throughout the coating and the substrate can be more uniform at any given time during the heating process than if the coating and substrate had been heated exclusively by the passage of warm air over the air-coating interface. The temperature of the coating at greater depths, i.e., greater distances from the air-coating interface, can be greater than the temperature at lesser depths, i.e., close to the air-coating interface. The temperature of the substrate can be greater than the temperature of the coating. For example, infrared heating can be used during the early part of the curing process, when the coating contains a large fraction of volatile material, and care should be taken to avoid formation of a skin. When greater depths of the coating have or the substrate has a higher temperature than lesser depths of the coating, cure can proceed more rapidly at greater than at shallower depths of the coating. As a result, the formation of a skin adjacent to the air-coating interface can be avoided, and gas evolved by the more rapidly curing material at greater depths can transport through the less rapidly curing material at shallower depths. This can help avoid the formation of blisters, pockmarks or trapped bubbles on or in the coating, so that the coating can have a good optical quality.

In an embodiment, the source of infrared radiation is selected to have a spectrum, i.e., a distribution of infrared radiation over wavelengths, so that more infrared radiation per unit substrate mass is absorbed by the substrate than infrared radiation per unit coating mass is absorbed by the coating. A coating can have a different infrared absorbance spectrum than a substrate has. By selecting the source of infrared radiation to have greater intensity at wavelengths where the substrate has a large absorbance per unit thickness, and the coating has a smaller absorbance per unit thickness, and to have a lesser intensity at wavelengths where the coating has a large absorbance per unit thickness and the substrate has a smaller absorbance per unit thickness, the temperature of the substrate can be rendered greater than the temperature of the coating. Thus, the temperature of the coating at greater depths can be higher than the temperature of the coating at shallower depths, i.e., closer to the air-coating interface.

The source of infrared radiation can be selected to have a spectrum through a number of ways. For example, a radiator can be heated to a selected radiator temperature: if the radiator is a close approximation to a blackbody, the distribution of energy across wavelengths will vary with temperature according to the Planck radiation formula. Alternatively, the radiator can be selected to not be a blackbody, but rather to have certain emissivity at certain wavelengths; the radiator can be selected to have a high emissivity at wavelengths for which the substrate exhibits large absorbance per unit thickness and the coating has smaller absorbance per unit thickness. A radiator can be, for example, an electrically conductive filament, which is ohmically heated by passing an electrical current through the filament. A radiator can be an object which is externally heated, for example, by a flame. By selecting the material of which the filament or the object is formed, the distribution of infrared radiation over wavelengths at a given temperature can be chosen. The source of infrared radiation can also be reflector. For example, infrared radiation can be directed onto a plate or a curved surface made of a material which exhibits greater reflectance at certain wavelengths than others; the radiation reflected from the plate or curved surface can then be directed onto the coated substrate. Alternatively, the source of infrared radiation can be an infrared filter. The filter can be designed, for example, the material of which the filter is formed can be selected, so that the filter exhibits a small transmittance for certain wavelengths but a large transmittance for other wavelengths. By selecting the material of which a reflector or a filter is formed, the distribution of infrared radiation over wavelengths can be chosen. A reflector or a filter can be cooled to prevent overheating by, for example, a fluid, such as air or water in a water jacket.

In another embodiment, the heat sensitive substrate is selected or treated such that it absorbs more infrared radiation per unit substrate mass than the infrared radiation the heat curable coating absorbs per unit coating mass. For example, certain polymer substrates or certain mixtures of polymer substrates with nonpolymeric materials, such as fillers, can be suitable for containing food or beverage products, and can absorb more infrared radiation per unit mass than a coating on the polymeric substrates. Alternatively, a polymer substrate used for containing food or beverage products can be pigmented so that the polymer substrate absorbs more infrared radiation per unit mass than a coating. When the substrate absorbs infrared radiation more strongly than the coating, the temperature of the coating at greater depths can be higher than the temperature of the coating at shallower depths; such a temperature profile can help to avoid the formation of blisters, pockmarks or trapped bubbles of the coating.

In an embodiment, the heat sensitive substrate can be chosen from a polyester, such as polyethylene terephthalate (PET), a polyolefin, such as polyethylene, high density polyethylene or polypropylene, or a polyamide, such as nylon 6, nylon 12 or nylon 66, or any combination of these. For example, the substrate can include a polyester, PET, and a polyamide, such as nylon 6, nylon 12 or nylon 66. The heat sensitive substrate can be, for example, a polymer having a softening temperature of less than about 100° C.

In the uncured state, the heat curable coating can include an epoxy formulation. For example, the uncured heat curable coating can include an amine and an epoxide. The amine can be an amine including one amine unit, an oligomeric amine, i.e., an oligoamine, or a polyamine. The epoxide can be an epoxide including one epoxide unit, an oligomeric epoxide, i.e., an oligoepoxide, or a polyepoxide.

The heat sensitive substrate can include a container, for example, a food packaging container. The coated substrate can form the wall of a container. After cure, the coating can provide a gas barrier in order to retain a gas within a container; e.g., the gas barrier can retain carbon dioxide within containers for carbonated beverages. The coating can also provide a gas barrier in order to block the passage of a gas into the container; e.g., the gas barrier can exclude oxygen from a container for a perishable food product. A coating imparting other desirable properties can also be cured according to the invention. The heat sensitive substrate, for example, a polymer substrate, can provide mechanical strength to the container. For example, the substrate can provide the container with puncture and crush resistance.

In an embodiment, the coated substrate is initially heated with infrared radiation and is subsequently heated by contact with a warm fluid. The initial heating can be by infrared radiation only or by infrared radiation and by contact with a warm fluid. The subsequent heating can be by contact with a warm fluid only or by contact with a warm fluid and by infrared radiation. For example, the coated substrate can be initially heated by exposure to infrared radiation and by contact with a warm fluid; the coated substrate can be subsequently heated by contact with a warm fluid and not by exposure to infrared radiation. The warm fluid can include warm air, such as in an oven, and flowing warm air, such as in a convection oven. Exposing the coated substrate to infrared radiation means exposing the coated substrate to directed infrared radiation, such as infrared radiation from a lamp with an ohmically heated filament, a radiator heated by a flame, or a mirror for directing and/or focusing a source of infrared radiation. For example, the temperature of an infrared radiator or filament used to produce directed infrared radiation can be much higher than the temperature attained by the heat curable coating or the heat sensitive substrate during a process for curing the coating. For example, exposing the coated substrate to infrared radiation can be considered to not include exposure to infrared radiation emitted by the warm fluid in the oven.

Heating with infrared radiation is believed to be most useful in earlier parts of the curing process, when the greatest concern is the avoidance of skin formation with the associated defects of blisters, pockmarks or trapped bubbles. Once higher degrees of cure are attained throughout various depths of the coating, the avoidance of skin formation becomes less of a concern. The rate of evolution of gas may decrease, for example, because the majority of any solvent in the coating composition has been released. Consequently, maintaining a temperature versus coating depth profile which is uniform or close to uniform or maintaining a profile in the coating for which the temperature in the coating is greatest at the coating-substrate interface becomes less important once higher fractions of cure are achieved throughout the coating.

At higher fractions of cure, for which higher temperatures are required to maintain an acceptable rate of cure, avoidance of or minimization of the time during which the temperature of the polymeric substrate exceeds the softening temperature of the substrate is thought to be important. When a higher fraction of cure is reached, it can be preferential to have a temperature-depth profile in which the temperature of the coating is highest near to the air-coating interface, lower near to the coating-substrate interface, and least within the polymeric substrate. Heating with a warm fluid adjacent to the air-coating interface can induce such a temperature-depth profile. Specifically, elevated temperatures can be imposed throughout the coating while temperatures lower than the softening temperature of the substrate are maintained throughout most or all of the substrate, or the time for which temperatures in the substrate exceed the softening temperature of the substrate is minimized. Because the heat sensitive substrate is not exposed to a temperature greater than the softening temperature of the substrate, or the heat sensitive substrate is only exposed to a temperature greater than the softening temperature for a short period of time, the substrate can be not substantially deformed by the method of curing. For example, no substantial deformation of a container can include the longest perimeter around a container including the heat sensitive substrate decreasing between the start of the initial heating and the end of the subsequent heating by less than or equal to about 2%, by even less than or equal to about 1%, or by even less than or equal to about 0.5%.

For example, the initial heating and the subsequent heating can be conducted so that the temperature of the heat sensitive substrate does not exceed about 125° C., does not exceed about 105° C., or does not exceed about 88° C. The total heat curing time can be the total duration of initial heating and subsequent heating. For example, the total duration of initial heating and subsequent heating can be equal to or less than about 550 seconds, and the total heat curing time can be equal to or less than 550 seconds. The total duration of initial heating and subsequent heating can be from about 300 to about 550 seconds, and the total heat curing time can be from about 300 to about 550 seconds. The total duration of initial heating and subsequent heating can be from about 300 to about 350 seconds, and the total heat curing time can be from about 300 to about 350 seconds. The total duration of initial heating and subsequent heating can be about 320 seconds, and the total heat curing time can be about 320 seconds.

The temperature of the coating, a point near to the coating, and the substrate can be controlled through the stepwise or continuous control of heating parameters. For example, the irradiance, i.e., the energy of the impinging radiation per unit time per unit area, of the coated substrate by infrared radiation can be varied during the exposure of the coated substrate to infrared radiation. The temperature of the warm fluid can be varied during contact of the coated substrate with the warm fluid. The flow rate of the warm fluid can be varied during contact of the coated substrate with the warm fluid.

The temperature of the heat sensitive substrate during the initial heating can be less than the softening temperature of the heat sensitive substrate. The temperature of a point near to the coating can be greater than the glass transition temperature of the coating substantially throughout the initial heating and substantially throughout the subsequent heating. The temperature of a point near to the coating and the glass transition temperature of the coating can be greater at the start of the initial heating than at the end of the subsequent heating. The difference between the temperature of a point near to the coating and the glass transition temperature of the coating can be in the range of from about 5° C. to about 50° C. substantially throughout the initial heating and substantially throughout the subsequent heating.

The initial heating and the subsequent heating can be conducted in an oven. The same oven can be used for subsequent heating as for initial heating. For example, initial heating can be carried out in the oven by exposing the coated substrate to infrared radiation alone or by exposing the coated substrate to infrared radiation and to a warm fluid. Subsequent heating in the oven can then be carried out by exposing the coated substrate to a warm fluid alone or by exposing the coated substrate to a warm fluid and to infrared radiation. For example, after initially heating, an infrared radiator, such as an infrared lamp, can be shut off before subsequently heating.

Alternatively, a different oven can be used for subsequent heating than for initial heating. One or more than one oven can be used for initial heating, and one or more than one oven can be used for subsequent heating. For example, an oven can supply the infrared radiation and the warm fluid for initially heating; a different oven can supply the warm fluid for subsequently heating.

In an embodiment, the coating on the substrate is initially heated by simultaneous application of infrared radiation and a warm fluid, such as flowing warm air. Such combined heating is thought to achieve temperature-depth profiles at given times which are intermediate to those that would be achieved by the application of infrared radiation alone or by the application of a warm fluid alone. After initial heating with infrared radiation and a warm fluid, the coating on the substrate can be subsequently heated with only a warm fluid, such as flowing warm air.

The coated substrate can be heated in a first oven for from about 10% to about 15% of a total heat curing time, for example, for about 12% of the total heat curing time. The power of the infrared lamps, the temperature of the warm fluid, and/or the velocity of flowing warm fluid can be selected. The temperature of the warm fluid, such as air, in the oven can be from about 80° C. to about 85° C. For example, the temperature of a warm fluid in the oven can be about 85° C. The coated substrate can be initially heated in the first oven.

The coated substrate can be heated in a second oven for from about 10% to about 30% of the total heat curing time, for example, for about 20% of the total heat curing time. The power of the infrared lamps, the temperature of the warm fluid, and/or the velocity of flowing warm fluid can be selected. The temperature of the warm fluid, such as air, in the oven can be from about 77° C. to about 82° C. For example, the temperature of a warm fluid in the oven can be about 82° C. The coated substrate can be initially heated in the second oven.

The coated substrate can be heated in a third oven for from about 25% to about 40% of the total heat curing time, for example, for about 35% of the total heat curing time. The temperature of the warm fluid and/or the velocity of flowing warm fluid can be selected. The temperature of the warm fluid, such as air, in the oven can be from about 83° C. to about 87° C. For example, the temperature of a warm fluid in the oven can be about 85° C. The coated substrate can be subsequently heated in the third oven.

The coated substrate can be heated in a fourth oven for from about 25% to about 40% of the total heat curing time, for example, for about 35% of the total heat curing time. The temperature of the warm fluid and/or the velocity of flowing warm fluid can be selected. The temperature of the warm fluid, such as air, in the oven can be from about 86° C. to about 90° C. For example, the temperature of a fluid in the oven can be about 88° C. The coated substrate can be subsequently heated in the fourth oven.

In an embodiment, the coated substrate can be conveyed through and exposed to conditions in the first oven. After the coated substrate has been conveyed through the first oven, the coated substrate can be conveyed through and exposed to conditions in the second oven. After the coated substrate has been conveyed through the second oven, the coated substrate can be conveyed through and exposed to conditions in the third oven. After the coated substrate has been conveyed through the third oven, the coated substrate can be conveyed through and exposed to conditions in the fourth oven.

The FIGURE illustrates an exemplary embodiment of a process for curing a heat curable coating 16 on a heat sensitive substrate 18. The heat curable coating 16 and the heat sensitive substrate 18 together can form a container 6. The container 6 can be transported by a conveying device through a first oven 1. The conveying device can be, for example, a conveyor belt or a chain 20 having chucks 22 to carry the containers 6 suspended in the air in the direction indicated by the arrow 30. While traveling through the first oven 1, the container 6 is heated both by flowing warm air 10 and by infrared radiation 12 produced by infrared lamps 14. After passing through the first oven 1, the container 6 continues to travel via the conveying device, e.g., the chain 20 and chuck 22, to a second oven 2 in which the container is heated both by flowing warm air 10 and by infrared radiation 12 produced by infrared lamps 14. After passing through the second oven 2, the container 6 continues to travel via the conveying device to a third oven 3, in which the container 6 is heated only by flowing warm air 10 and not by infrared radiation. After exiting the third oven 3, the container passes into a fourth oven 4, in which the container 6 is heated only by flowing warm air 10 and not by infrared radiation.

Several factors determine the optimal setting of the power supplied to the infrared lamps and the duration of exposure to infrared radiation and the temperature of the warm fluid and the duration of exposure to warm fluid of the coated substrate during initially and subsequently heating. For example, if a large quantity of gas is expected to be evolved during the curing of the coating, for example, because the coating is thick, a long duration of exposure to infrared radiation can be selected. The long duration of exposure to infrared radiation can result in a uniform distribution of temperature in the coating or can result in the temperature at greater depths of the coating, i.e., farther from the air-coating interface, being greater that the temperature at lesser depths of the coating, i.e., closer to the air-coating interface. Such a temperature distribution in the coating can minimize the formation of defects such as blisters, pockmarks or included bubbles. Alternatively, if the softening temperature of the heat sensitive substrate is low, a shorter duration of exposure to infrared radiation or a lower power supplied to the infrared lamps can be selected, and a somewhat longer duration of exposure to warm fluid can be selected. Heating the coating with warm fluid can result in the coating having a greater temperature than the underlying substrate; as a result, substantially full cure of the coating can be achieved with minimal deformation of the substrate. The ability to, for example, select the distribution of infrared radiation over wavelengths emitted by infrared radiators, the power supplied to the infrared radiators, the temperature of a warm fluid, forced circulation of a warm fluid or no forced circulation, the velocity of a warm fluid forced to circulate, the duration of exposure to infrared radiation, the duration of exposure to warm fluid, and the variation of heating parameters such as these through stepwise or continuous control provides a user of a method of curing according to the present invention with great flexibility in optimizing conditions in one or more ovens for curing a heat curable coating on a heat sensitive substrate. Conditions in an oven can include, for example, the distribution of infrared radiation over wavelengths, the flux, i.e., the power per unit area of infrared radiation at various locations in the oven, the temperature of a fluid, such as air, in the oven, and the velocity of a fluid, such as air, in the oven.

Oven control parameters, for example, parameters pertaining to infrared heating devices and devices for heating with warm air, can be adjusted for the curing of a heat curable coating on a heat sensitive substrate in order to, for example, maximize the fraction of cure of the coating, minimize defects in or on the coating, and minimize deformation of the substrate. The parameters can be adjusted based on measurements of physical-chemical properties of the coated substrate. Examples of measured physical-chemical properties include, but are not limited to the following: deformation of the substrate, for example, the change in the longest perimeter around the substrate, such as the longest perimeter around a container including the substrate; the optical quality of the coating; the glass transition temperature of the coating; the fraction and uniformity of cure of the coating; the temperature of a point near to the coating; and the temperature of a substrate, for example, as measured by a thermocouple contacting an uncoated side of the substrate. For example, the glass transition temperature of the coating at a specific time in the oven can be measured by removing the coating from the oven at that specific time during a test, quenching the coated substrate, and performing a differential scanning calorimetry measurement on a sample of coating from the coated substrate; the fraction of cure can be inferred from the differential scanning calorimetry data. Deformation of the substrate can be characterized and the optical quality of the surface can be characterized, for example, characterized in terms of the areal density of pockmarks, blisters or trapped bubbles, by visual observation or by a camera and image processing. The fraction and uniformity of cure of the coating can be characterized by, for example, a test which measures the tack of the surface, a staining test, or a test which determines the glass transition temperature of the coating. The temperature of a point near to the coating, measured with a thermocouple probe while the coated substrate is still in the oven, has exited the oven, or both is useful. Oven control parameters pertaining to heating with a warm fluid can include, without being limited to the following: duration of exposure to warm fluid, e.g., to warm air; temperature of the warm fluid; whether or not the warm fluid is forced to circulate; and, if forced to circulate, the velocity of the warm air. Oven control parameters pertaining to heating with infrared radiation can include, without being limited to the following: duration of exposure to infrared radiation; electrical power supplied to infrared lamps; and distribution of infrared radiation over wavelengths.

The oven control parameters can be varied under a stepwise control regime; for example, different oven parameters can be set for different intervals, and the duration of the intervals can be set. For example, the duration of intervals in which infrared radiation and/or warm air is applied to increase the temperature of the coating or maintain the coating temperature above the glass transition temperature of the coating can be set. The duration of intermediate intervals during which infrared radiation and warm air are not applied to increase the coating temperature or maintain the coating temperature above the glass transition temperature of the coating can be set. For example, infrared lamps can be set on at a low power setting for a first duration, infrared lamps can then be set off for a second duration, and infrared lamps can then be set on at a high power setting for a third duration. The oven control parameters can be varied under a continuous control regime; for example, the rate of change of one or more oven control parameters can be set for each time during the curing process. For example, warm air surrounding the coated substrate can be at a moderate temperature at first and then increased to a high temperature over time.

Oven control parameters can be optimized for an oven in a system for curing a coating. At the start of an optimization method, oven controls can be set with an initial set of parameters; variation of the parameters through stepwise or continuous control can also be set. Physical-chemical properties of the coating can be measured and additional quantities, for example, the substrate temperature, can be measured after the coated substrate has exited the oven or while the coated substrate is in the oven. Certain measurements can be continuously obtained while the coated substrate is in the oven; for example, the temperature of a point near to the coating can be measured by a thermocouple. Other measurements can be obtained by removing a coated substrate from an oven during a trial; for example, the coated substrate can be removed and the glass transition temperature of the coating can be measured by differential scanning calorimetry.

The physical-chemical properties and any other quantities measured can be used to determine how one or more oven control parameters should be adjusted. For example, if the substrate is deformed upon exiting the oven, and the substrate was exposed to warm air in the oven, an individual supervising the process can decide to reduce the duration of exposure of the coated substrate to warm air or to reduce the temperature of the warm air. If the coating is not substantially fully cured at the end of the curing process, or does not have a target fraction of cure at an intermediate time during the process, the temperature of the warm air can be increased, the irradiance of the coated substrate by infrared radiation can be increased, or the duration of exposure of the coated substrate to flowing warm air or infrared radiation can be increased. If the optical quality of the coating is poor, the temperature of or duration of exposure of the coated substrate to warm air can be decreased, and the power provided to infrared lamps, the irradiance of the coated substrate by infrared radiation, or the duration of exposure of the coated substrate to the infrared radiation can be increased. Weight can be assigned to each physical-chemical parameter of interest, so that if target values of all physical-chemical properties cannot be achieved, oven control parameters can be adjusted to, for example, optimize the sum of the weighted differences between achieved and target values of each physical-chemical property. Appropriate weights can be assigned by one skilled in the art, for example, a process engineer.

For example, if the substrate is deformed and the coating is not fully cured, the power provided to infrared lamps can be decreased while increasing the temperature of and duration of exposure of the coated substrate to warm air. After the values of measured physical-chemical properties of the coated substrate and other measured quantities have been evaluated and a decision as to how to adjust the oven control parameters has been reached, the oven control parameters can be adjusted for a subsequent trial with another coated substrate in the oven. The process of exposing a coated substrate to conditions in an oven, measuring at least one physical-chemical property of the substrate, determining how oven control parameters should be changed, and adjusting oven control parameters can be repeated, until, for example, one or more physical-chemical properties meet a predetermined value or values or specification or specifications. For example, the oven control parameters for the oven can be adjusted simultaneously based on physical-chemical property measurements of a coated substrate taken after the coated substrate has been subjected to the cure process and/or while the coated substrate is in the oven. The values or specifications can be predetermined by one skilled in the art, for example, a process engineer.

In an embodiment, measured physical-chemical property information can be stored in an electronic database, and a computer program used to determine the adjustment of oven control parameters. The computer program can be capable of learning, i.e., capable of basing an adjustment of oven control parameters on measured physical-chemical properties and oven control parameters of previous trials of a curing process as well as of a current trial.

The method for optimizing a cure process through adjustment of oven control parameters of one oven can also be applied to a cure process carried out in two or more ovens. For example, the oven control parameters for each oven can be adjusted simultaneously based on physical-chemical property measurements of a coated substrate taken in an oven, or after the coated substrate exits or is removed from an oven; physical-chemical property measurements of coated substrates taken in more than one oven or after the coated substrates exit or are removed from more than one oven; or physical-chemical property measurements of coated substrates taken in all ovens or after the coated substrates exit or are removed from all ovens.

In an embodiment of the present invention, a container includes a thermoplastic substrate and a crosslinked epoxy coating on the thermoplastic substrate. The crosslinked epoxy coating can be substantially smooth and uniform. The glass transition temperature of the crosslinked epoxy coating can be greater than the glass transition temperature of the thermoplastic substrate. The longest perimeter around the container can decrease by at least about 0.3% when the container is heated above the glass transition temperature of the thermoplastic substrate for a time period sufficient for residual stresses in the thermoplastic substrate to relax; the longest perimeter around the container can even decrease by at least about 0.5% when the container is heated above the glass transition temperature of the thermoplastic substrate for a time period sufficient for residual stresses in the thermoplastic substrate to relax. Residual stresses in the substrate can be a result of the previous processing history of the substrate, for example, forming of the substrate in a blow molding operation. Heating for a time period sufficient for residual stresses to relax means heating for a time period sufficient for residual stresses in the substrate to dissipate, for example, through shrinkage of the substrate, but not so long that the shape of the substrate, e.g., the substrate in a container, changes primarily because of the influence of other forces, such as gravity. A change in the shape of the container because of the dissipation of residual stresses can appear, for example, as a change in all of the dimensions of the container, and can appear as a change in dimensions expected to be unaffected by gravity, for example, a change in dimensions in the plane normal to the direction in which gravity acts. A change in the shape of the container because of the influence of gravity can appear, for example, as a sagging or collapse of the container in the direction in which gravity acts.

The thermoplastic substrate can be chosen from, for example, a polyester, such as polyethylene terephthalate, a polyolefin, such as polyethylene, high density polyethylene or polypropylene, and a polyamide, such as nylon 6, nylon 12 or nylon 66, or any combination of these. The crosslinked epoxy coating can include an amine and an epoxide. The crosslinked epoxy coating can have good optical quality; for example, the crosslinked epoxy coating can be optically clear.

The embodiments illustrated and discussed in this specification are intended only to teach those skilled in the art the best way known to the inventors to make and use the invention. Nothing in this specification should be considered as limiting the scope of the present invention. All examples presented are representative and nonlimiting. The above described embodiments of the invention may be modified or varied, and elements added or omitted, without departing from the invention, as appreciated by those skilled in the art in light of the above teachings. It is therefore to be understood that, within the scope of the paragraphs and their equivalents, the invention may be practiced otherwise than as specifically described.

1. A method of curing a heat curable coating on a heat sensitive substrate, comprising:
providing the heat sensitive substrate coated with an uncured heat curable coating;
initially heating the coated substrate by exposure to infrared radiation;
subsequently heating the coated substrate by contact with a warm fluid, wherein
after subsequently heating the coated substrate, the coating is substantially cured, the coating has good optical quality, and the heat sensitive substrate is not substantially deformed.

2. (canceled)

3. The method of claim 1, wherein the heat sensitive substrate comprises a food packaging container.

4. The method of claim 1, wherein the temperature of the heat sensitive substrate does not exceed about 125° C.

5. The method of claim 1, wherein the heat sensitive substrate comprises a polymer having a softening temperature of less than about 100° C.

6. The method of claim 1, wherein the heat sensitive substrate comprises a polymer selected from the group consisting of polyester, polyethylene terephthalate, polyolefin, polyethylene, high density polyethylene, polypropylene, polyamide, nylon 6, nylon 12, and nylon 66.

7. (canceled)

8. The method of claim 1, the uncured heat curable coating comprising an epoxy formulation.

9. (canceled)

10. The method of claim 1,
wherein the heat sensitive substrate is a polymer substrate and
wherein a temperature of the heat sensitive substrate does not exceed about 105° C.

11. The method of claim 10, wherein a total duration of the initial heating and the subsequent heating is from about 300 to about 350 seconds.

12. The method of claim 10, wherein the temperature of the heat sensitive substrate does not exceed about 88° C.

13. The method of claim 1, wherein a source of the infrared radiation is selected to have a spectrum wherein more infrared radiation per a unit substrate mass is absorbed by the heat sensitive substrate than infrared radiation per a unit coating mass is absorbed by the coating.

14. (canceled)

15. (canceled)

16. (canceled)

17. The method of claim 1, wherein a temperature of the heat sensitive substrate during the initial heating is less than a softening temperature of the heat sensitive substrate.

18. The method of claim 1, wherein the temperature of a point near to the coating is greater than a glass transition temperature of the coating substantially throughout the initial heating and substantially throughout the subsequent heating.

19. (canceled)

20. (canceled)

21. The method of claim 1, wherein not substantially deformed comprises a longest perimeter around a container comprising the heat sensitive substrate decreasing by less than or equal to about 2% between a start of the initial heating and an end of the subsequent heating.

22. (canceled)

23. The method of claim 1, wherein not substantially deformed comprises a longest perimeter around a container comprising the heat sensitive substrate decreasing by less than or equal to about 0.5% between a start of the initial heating and an end of the subsequent heating.

24. (canceled)

25. The method of claim 1, wherein the temperature of the point near to the coating increases in a stepwise manner during the initial heating and during the subsequent heating.

26. The method of claim 1, wherein an irradiance of the coating by infrared radiation is varied during exposure of the coated substrate to the infrared radiation.

27. The method of claim 1, wherein a temperature of the warm fluid is varied during contact of the coated substrate with the warm fluid.

28. (canceled)

29. (canceled)

30. The method of claim 1,
wherein the initial heating further comprises heating the coated substrate by contact with a warm fluid and
wherein the subsequent heating does not comprise heating by exposure to infrared radiation.

31. The method of claim 30, further comprising:
providing an oven for supplying the infrared radiation and the warm fluid for the initial heating; and
providing a different oven for supplying the warm fluid for the subsequent heating.

32. The method of claim 31,
wherein the initial heating comprises exposing the coated substrate to conditions in a first oven for from about 10% to about 15% of a total heat curing time and
wherein the first oven maintains an air temperature of from about 80° C. to about 85° C.

33. The method of claim 31,
wherein the initial heating comprises exposing the coated substrate to conditions in a second oven for from about 10% to about 30% of a total heat curing time and
wherein the second oven maintains an air temperature of from about 77° C. to about 82° C.

34. The method of claim 31,
wherein the subsequent heating comprises exposing the coated substrate to conditions in a third oven for from about 25% to about 40% of a total heat curing time and
wherein the third oven maintains an air temperature of from about 83° C. to about 87° C.

35. The method of claim 31,
wherein the subsequent heating comprises exposing the coated substrate to conditions in a fourth oven for from about 25% to about 40% of a total heat curing time and
wherein the fourth oven maintains an air temperature of from about 86° C. to about 90° C.

36. The method of claim 31, wherein a total heat curing time is from about 300 to about 550 seconds.

37. (canceled)

38. The method of claim 31, comprising:
conveying the coated substrate through a first oven;
exposing the coated substrate to conditions in the first oven for from about 10% to about 15% of a total heat curing time;
maintaining an air temperature in the first oven of from about 80° C. to about 85° C.;
conveying the coated substrate through a second oven after having conveyed the coated substrate through the first oven;
exposing the coated substrate to conditions in the second oven for from about 10% to about 30% of the total heat curing time;
maintaining an air temperature in the second oven of from about 77° C. to about 82° C.;
conveying the coated substrate through a third oven after having conveyed the coated substrate through the second oven;
exposing the coated substrate to conditions in the third oven for from about 25% to about 40% of the total heat curing time;
maintaining an air temperature in the third oven of from about 83° C. to about 87° C.;
conveying the coated substrate through a fourth oven after having conveyed the coated substrate through the third oven;
exposing the coated substrate to conditions in the fourth oven for from about 25% to about 40% of the total heat curing time; and
maintaining an air temperature in the fourth oven of from about 86° C. to about 90° C.,
wherein the total heat curing time is from about 300 seconds to about 350 seconds.

39. A method of optimizing curing of a heat curable coating on a heat sensitive substrate, comprising:
(a) providing an oven;
(b) setting oven controls to an initial set of parameters for the oven;
(c) providing the heat sensitive substrate coated with an uncured heat curable coating;
(d) exposing the coated substrate to conditions in the oven;
(e) measuring at least one physical-chemical property of the coated substrate, selected from the group consisting of substrate deformation, coating surface optical quality, glass transition temperature of the coating, coating cure fraction, coating cure uniformity, and coating temperature while the coated substrate is in the oven or after the coated substrate has been removed from the oven;
(f) adjusting the oven controls for the oven; and
(g) repeating at least one of steps (c) through (f) until at least one physical-chemical property of the coated substrate meets a predetermined specification.

40. (canceled)

41. A container, comprising:
a thermoplastic substrate; and
a crosslinked polymer coating on the thermoplastic substrate,
wherein the crosslinked polymer coating is substantially smooth and uniform,
wherein a glass transition temperature of the crosslinked polymer coating is greater than a glass transition temperature of the thermoplastic substrate, and
wherein a longest perimeter around the container decreases by at least about 0.3% when the container is heated above the glass transition temperature of the thermoplastic substrate for a time period sufficient for residual stresses in the thermoplastic substrate to relax.

42. The container of claim 41, wherein a longest perimeter around the container decreases by at least about 0.5% when the container is heated above the glass transition temperature of the thermoplastic substrate for a time period sufficient for residual stresses in the thermoplastic substrate to relax.

43. (canceled)

44. The container of claim 41,
wherein the crosslinked polymer coating comprises a crosslinked epoxy coating,
wherein the crosslinked epoxy coating has good optical quality,
wherein the crosslinked epoxy coating comprises an amine and an epoxide, and
wherein the thermoplastic substrate comprises polyethylene terephthalate.

45. (canceled)

46. A container having a coating cured in accordance with the method of claim 1.

47. The container of claim 46,
wherein the heat sensitive substrate comprises a thermoplastic and
wherein the coating comprises a crosslinked polymer.

48. (canceled)

49. (canceled)

50. (canceled)
